(19) United States
(12) Patent Application Publication
(10) Pub. No.: US 2007/0133701 A1
(43) Pub. Date: Jun. 14, 2007

(54) Radio communications device and radio communications controlling method

(75) Inventor: Masashi Iwami, Ogaki-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/634,889

(22) Filed: Dec. 7, 2006

(30) Foreign Application Priority Data
Dec. 8, 2005 (JP) P2005-355463

(51) Int. Cl. H04K 1/10

(52) U.S. Cl. 375/260

(57) ABSTRACT

The present invention aims at ensuring both delayed wave resistance and fading resistance in good balance. A delay time measuring unit measures delay time determined based on a time point of a subcarrier out of a plurality of subcarriers arriving first and a time point of another subcarrier arriving through multipath at each predetermined time interval. A mode selector selects a mode out of a plurality of modes formed as combinations of a subcarrier interval representing an interval between mutually adjacent subcarriers out of the plurality of subcarriers and the guard interval depending on a length of the delay time. A first mode processor, a second mode processor or a third mode processor executes transmission and reception of a transmission signal by use of the selected mode.

### CROSS-REFERENCE TO RELATED APPLICATIONS

This application is based upon and claims the benefit of priority from the prior Japanese Patent Applications No. P2005-355463, filed on Dec. 8, 2005; the entire contents of which are incorporated herein by reference.

### BACKGROUND OF THE INVENTION

1. Field of the Invention

The present invention relates to a radio communications device and a radio communications controlling method, which are configured to execute transmission and reception of a transmission signal formed by multiplexing a transmission symbol containing a guard interval by use of at least a part of a plurality of subcarriers.

2. Description of the Related Art

Conventionally, data transmission is executed by a transmission symbol as a unit in a system using the orthogonal frequency division multiplexing technique (OFDM). Each transmission symbol includes a guard interval. The guard interval is a certain time interval to be inserted to reduce an influence of interference between the transmission symbols.

In this respect, extension of a length of a guard interval (hereinafter referred to as a “GI length”) improves resistance to interference between the transmission symbols (hereinafter referred to as “delayed wave resistance”). In the meantime, the extension of the GI length narrows an interval between mutually adjacent subcarriers (hereinafter referred to as a “subcarrier interval”), and this narrower interval reduces resistance to interference between the subcarriers (hereinafter referred to as “fading resistance”).

In contrast, reduction of the GI length widens the subcarrier interval, and this wider interval improves the fading resistance. In the meantime, the reduction of the GI length reduces the delayed wave resistance. As described above, if priority is given to the extension of the GI length, the fading resistance is reduced. If priority is given to the extension of the subcarrier interval, the delayed wave resistance is reduced.

FIG. 1 shows an example of delay time (μs) determined based on a time point of a first subcarrier that arrives first and a time point of a second subcarrier that arrives through multipath, and a power value (dB) of the second subcarrier.

As show in FIG. 1, the delay time varies depending on (a) a typical urban area, (b) a suburban area, (c) an urban area having a hilly landscape, and (d) a hilly area. Accordingly, in a system design applying the OFDM technique, it is necessary to set the GI length while considering the delay time.

Here, if the GI length is set equivalent to the delay time of 20 μs in order to obtain an appropriate delayed wave resistance in the hilly area shown in FIG. 1, the subcarrier interval becomes equal to or below 12.5 kHz, and the fading resistance is thereby deteriorated.

On the other hand, if the GI length is set equivalent to the delay time of 2 μs in order to obtain the delayed wave resistance which is appropriate only in the suburban area, the subcarrier interval becomes equal to or below 125 kHz. Accordingly, the fading resistance is improved, but the delayed wave resistance is deteriorated instead.

To solve this problem, there has been disclosed a radio communications device configured to set the GI length depending on the length of the delay time instead of fixing the GI length (Japanese Unexamined Patent Application Publication No. 2002-374223, for example).

### SUMMARY OF THE INVENTION

However, this radio communications device is merely configured to change the GI length depending on the length of the delay time, and is therefore incapable of ensuring both the delayed wave resistance and the fading resistance in good balance.

Specifically, in a situation where a communication environment (such as an urban area or a hilly area) between the radio communications device and a communication counterpart device (such as a mobile device) changes, the radio communications device cannot sufficiently ensure the delayed wave resistance and the fading resistance depending on the communication environment.

The present invention has been made in view of this problem. It is an object of the present invention to provide a radio communications device and a radio communications controlling method capable of ensuring both the delayed wave resistance and the fading resistance in good balance.

To solve the problem, a first aspect of the present invention provides a radio communications device configured to execute transmission and reception of a transmission signal formed by multiplexing a transmission symbol containing a guard interval by use of at least a part of a plurality of subcarriers. The device includes: a delay time measurement unit (a delay time measurement unit 15) configured to measure delay time determined based on a time point of a subcarrier out of the plurality of subcarriers arriving first and a time point of another subcarrier arriving through multipath at every predetermined time interval; a mode selector (such as a mode selector 117) configured to select a mode out of a plurality of modes (a first mode, a second mode, and a third mode shown in FIGS. 5A to 5C, for example) formed as combinations of a subcarrier interval representing an interval between mutually adjacent subcarriers out of the plurality of subcarriers and a guard interval depending on a length of the delay time; and a process executing unit (such as a first mode processor 130, a second mode processor 150 or a third mode processor 170) configured to execute the transmission and reception of the transmission signal by use of the selected mode.

According to this aspect, the radio communications device properly changes not only a length of the guard interval but also the subcarrier interval to those of a different mode depending on the length of the delay time. For this reason, the radio communications device can ensure both the delayed wave resistance and the fading resistance in good balance even in a situation where a communication environment between the communications device and a communication counterpart device changes.

In a second aspect of the present invention, the mode selector is configured to select one of the modes (as shown in FIG. 8, for example) at each of time slots obtained by dividing a frame to be repeated at a predetermined unit cycle (such as 2.5 ms).

In a third aspect of the present invention, the process executing unit allocates subchannels formed of the plurality of subcarriers to a single communication counterpart device (such as a terminal device 200-1). In a case where the plurality of subchannels are allocated to the single communication counterpart device, the mode selector changes the subcarrier interval with a wider subcarrier interval (as shown in FIGS. 9A and 9B, for example) in accordance with the selected mode.

In a fourth aspect of the present invention, a time length of the transmission symbol in accordance with the mode varies depending on the every mode, and a long transmission symbol (such as a transmission symbol in accordance with the second mode as shown in FIG. 5B) having a longer time length has the time length equivalent to an integral multiple of the time length of a short transmission symbol (such as a transmission symbol in accordance with the first mode as shown in FIG. 5A) which is shorter than that of the long transmission symbol.

According to the aspects of the present invention, it is possible to ensure both the delayed wave resistance and the fading resistance in good balance.

### BRIEF DESCRIPTION OF THE DRAWINGS

FIG. 1 is a characteristic graph showing a relationship between power values and delay time of subcarriers.

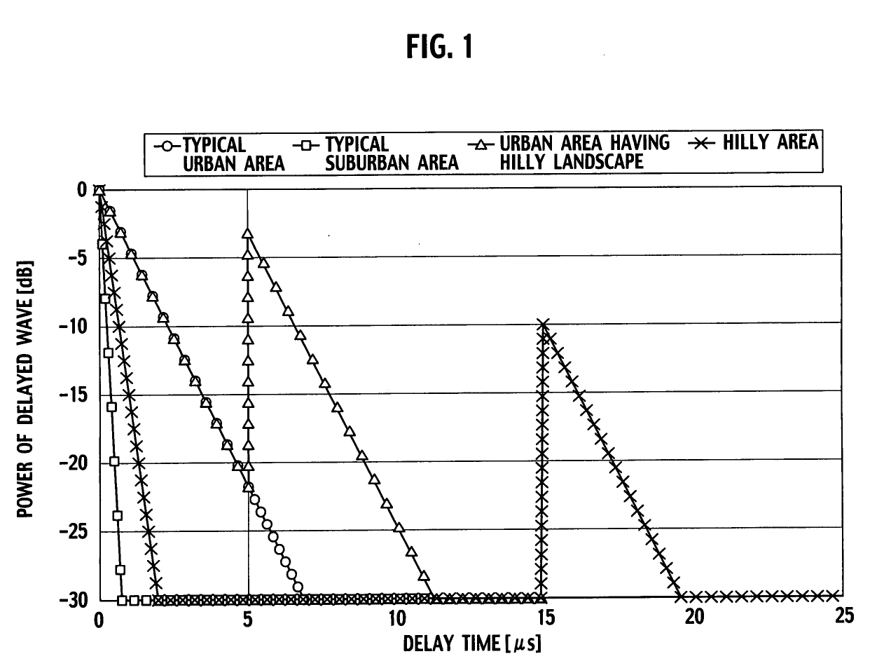

FIG. 2 is a view showing a radio base station and a plurality of terminal devices according to an embodiment of the present invention.

FIG. 3 is a view showing a block configuration of the radio base station according to the embodiment.

FIGS. 4A to 4C are views showing contents of a first mode, a second mode and a third mode according to the embodiment.

FIGS. 5A to 5C are other views showing the contents of the first mode, the second mode and the third mode according to the embodiment.

FIG. 6 is a flowchart showing an operation of the radio base station according to the embodiment.

FIGS. 7A to 7C are views showing modes to be selected for each subchannel according to a first modified example.

FIG. 8 is a view showing modes to be selected for each subchannel and each time slot according to a second modified example.

FIGS. 9A and 9B are views showing contents of a second mode and a second mode-expand according to a third modified example.

FIG. 10 is a view showing the second mode and the second mode-expand to be selected for each subchannel and each time slot according to the third modified example.

### DESCRIPTION OF THE PREFERRED EMBODIMENTS

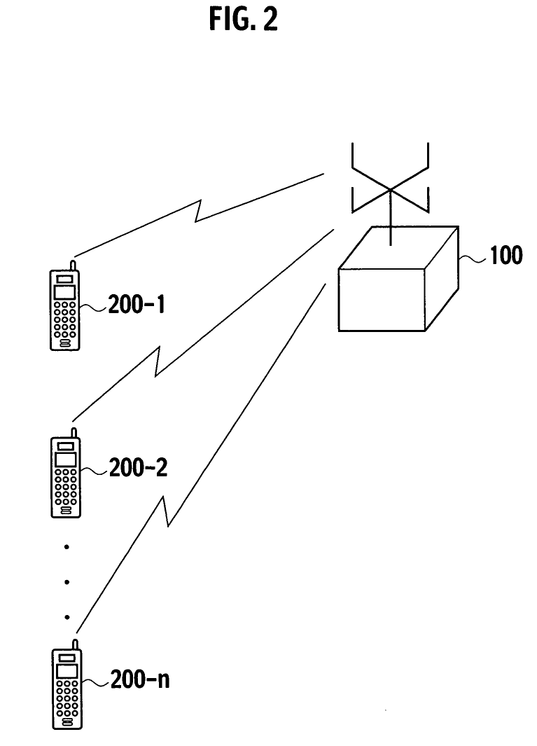

A radio base station and a terminal device according to an embodiment of the present invention will be described with reference to the accompanying drawings. FIG. 2 is a view showing a radio base station 100 and terminal devices 200-1 to 200-n according to the embodiment. Here, the radio base station 100 or the terminal devices 200-1 to 200-n constitutes a radio communications device.

As shown in FIG. 2, the radio base station 100 executes transmission and reception of a transmission signal formed by multiplexing a transmission symbol containing a guard interval (hereinafter referred to as GI) between the radio base station 100 and the terminal devices 200-1 to 200-n by use of at least a part of a plurality of subcarriers. The radio base station 100 executes the transmission and reception of the transmission signal by use of the orthogonal frequency division multiplexing technique.

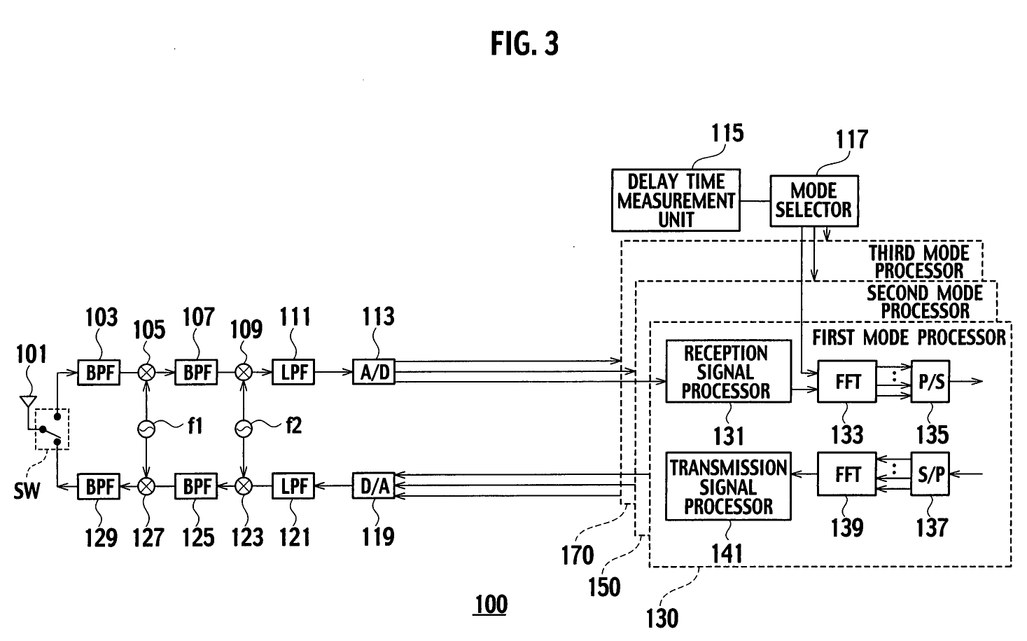

Next, a block configuration of the radio base station 100 will be described with reference to FIG. 3.

As shown in FIG. 3, the radio base station 100 includes an antenna 101, a switch SW, a receiver side BPF 103, a receiver side synthesizer 105, a receiver side BPF 107, a receiver side synthesizer 109, a receiver side LPF 111, an analog-digital converter (A/D) 113, a delay time measuring unit 115, a mode selector 117, a digital-analog converter (D/A) 119, a transmitter side LPF 121, a transmitter side synthesizer 123, a transmitter side BPF 125, a transmitter side synthesizer 127, and a transmitter side BPF 129. Moreover, the radio base station 100 includes a first mode processor 130, a second mode processor 150, and a third mode processor 170.

The antenna 101 executes transmission and reception of transmission signals (radio signals) between the antenna 101 and the terminal devices 200-1 to 200-n. The switch SW selects the receiver side BPF 103 or the transmitter side BPF 129. The receiver side BPF 103 outputs the transmission signals in a specific frequency band out of the transmission signals in a predetermined frequency band received by the antenna 101.

The receiver side synthesizer 105 converts the transmission signals outputted from the receiver side BPF 103 into the transmission signals in a first intermediate frequency band by use of a generated frequency f1. The receiver side BPF 107 outputs the transmission signals in a specific frequency band out of the transmission signals in the first intermediate frequency band which are outputted from the receiver side synthesizer 105.

The receiver side synthesizer 109 converts the transmission signals outputted from the receiver side BPF 107 into the transmission signals in a second intermediate frequency band by use of a generated frequency f2. The receiver side LPF 111 removes the transmission signals in a high-frequency band from the transmission signals outputted from the receiver side synthesizer 109. The A/D 113 converts the transmission signals outputted from the receiver side LPF 111 into digital signals.

In this way, the transmission signals received by the antenna 101 are sequentially converted into the transmission signals in the predetermined frequency bands by use of the receiver side BPF 103, the receiver side synthesizer 105, the receiver side BPF 107, the receiver side synthesizer 109, the receiver side LPF 111, and the A/D 113 (a receiver side conversion process).

Meanwhile, transmission signals to be transmitted are sequentially converted into transmission signals in predetermined frequency bands in accordance with reverse procedures of the receiver side conversion process. The converted transmission signals are transmitted to the terminal devices 200-1 to 200-n through the antenna 101 (a transmitter side conversion process).

The transmitter side conversion process are executed by use of the D/A 119, the transmitter side LPF 121, the transmitter side synthesizer 123, the transmitter side BPF 125, the transmitter side synthesizer 127, and the transmitter side BPF 129. Because, the process is similar to the reverse procedures of the receiver side conversion process, detailed explanations thereof will be omitted.

The delay time measuring unit 115 measures delay time at each predetermined time interval, which is determined based on a time point of a subcarrier out of the plurality of subcarriers that arrives first and a time point of another subcarrier that arrives through multipath.

The mode selector 117 selects a mode out of a plurality of modes depending on a length of the measured delay time. Each mode is formed as a combination of a subcarrier interval representing an interval between mutually adjacent subcarriers and the GI.

In this embodiment, the delay time measuring unit 115 measures the delay time at each predetermined time interval. Accordingly, the mode selector 117 selects one of the modes at each predetermined time interval depending on the length of the delay time.

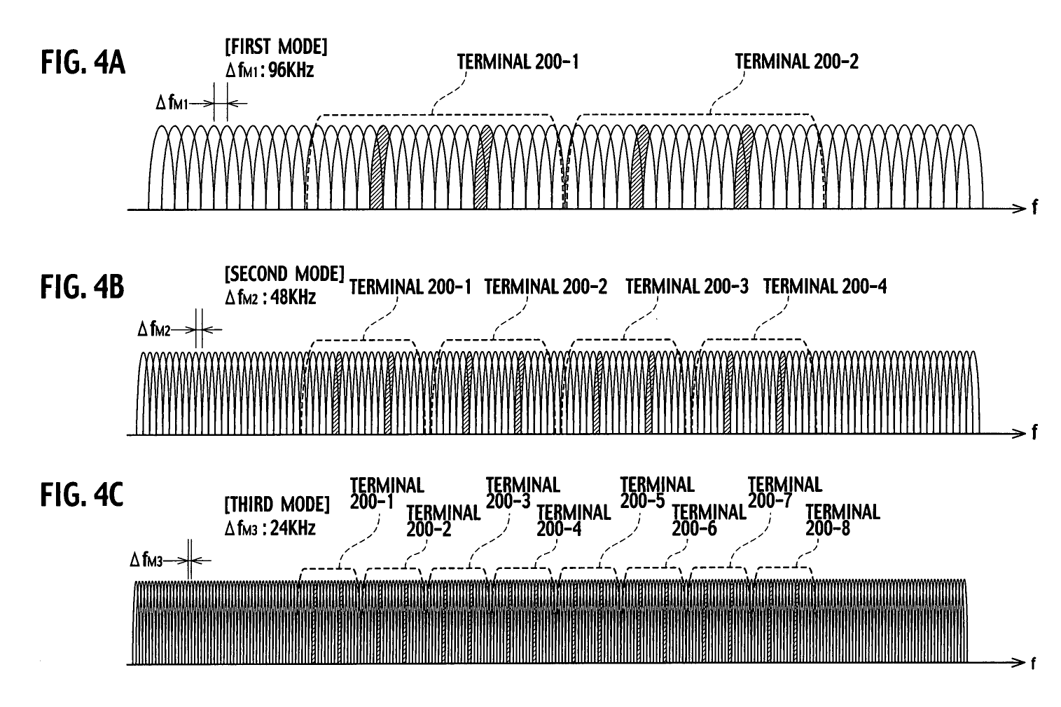

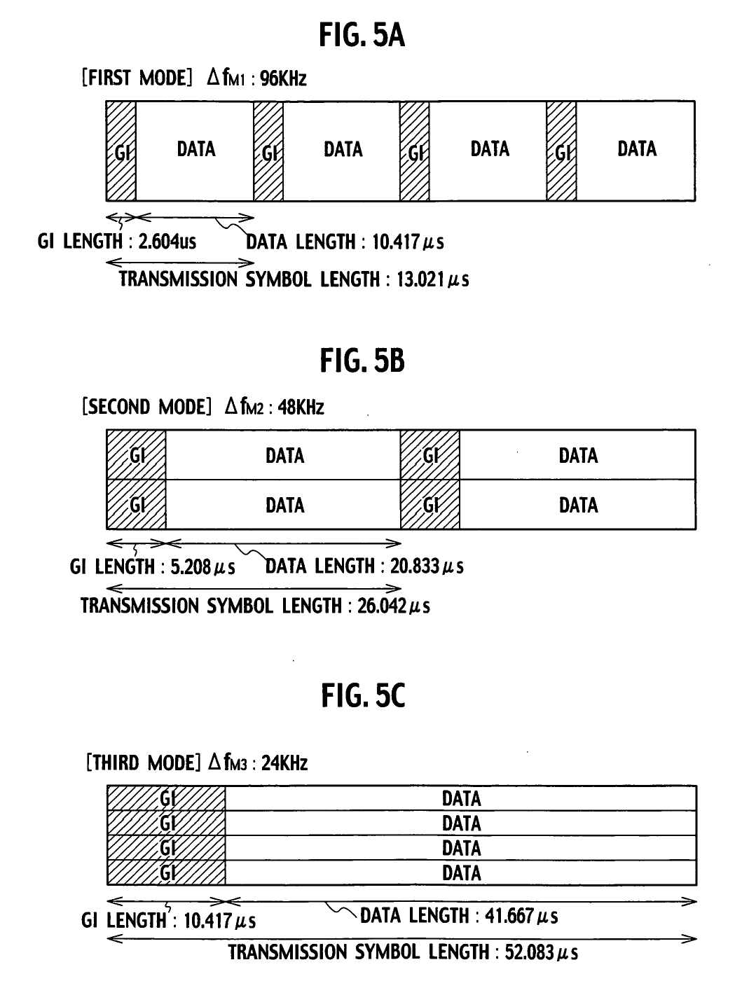

Here, the plurality of modes include a first mode, a second mode and a third mode. In this embodiment, a time length of the transmission signal varies depending on the mode. To be more precise, a long transmission symbol (such as a transmission symbol in accordance with the second mode as shown in FIG. 5B) having a longer time length has the time length equivalent to an integral multiple of a time length of a short transmission symbol (such as a transmission symbol in accordance with the first mode as shown in FIG. 5A) which is shorter than that of the long transmission symbol. Now, the respective modes will be described with reference to FIGS. 4A to 4C and FIGS. 5A to 5C.

FIGS. 4A to 4C are views showing the subcarrier intervals in accordance with the first mode, the second mode and the third mode. FIGS. 5A to 5C are views showing the transmission symbols in accordance with the first mode, the second mode and the third mode. The transmission symbol contains the GI and data.

As shown in FIG. 4A and FIG. 5A, the first mode is formed as a combination of 96 kHz representing a subcarrier interval ΔfM1 and 2.604 μs representing the GI length.

As shown in FIG. 4B and FIG. 5B, the second mode is formed as a combination of 48 kHz representing a subcarrier interval ΔfM2 narrower than the subcarrier interval ΔfM1 of the first mode and 5.208 μs representing the GI length longer than the GI length of the first mode. Moreover, a transmission symbol length (a time length) containing the GI length and the data length of the second mode is twice as long as the transmission symbol length containing the GI length and the data length of the first mode.

As shown in FIG. 4C and FIG. 5C, the third mode is formed as a combination of 24 kHz representing a subcarrier interval ΔfM3 narrower than the subcarrier interval ΔfM2 of the second mode and 10.417 μs representing the GI length longer than the GI length of the secondmode. Moreover, the transmission symbol length (the time length) containing the GI length and the data length of the third mode is twice as long as the transmission symbol length containing the GI length and the data length of the second mode.

Note that, although this embodiment is explained by using the subcarrier intervals (96 kHz, 48 kHz, and 24 kHz), the GI lengths (2.604 μs, 5.208 μs, and 10.417 μs), and the data lengths (10.417 μs, 20.833 μs, and 41.667 μs) as examples, it is needless to say that the parameters are not limited only to these values.

As shown in FIG. 3, the first mode processor 130 executes the transmission and reception of the transmission signals by use of the first mode selected by the mode selector 117 (a mode process). The first mode processor 130 includes a reception signal processor 131, an FFT 133, a P/S 135, an S/P 137, an FFT 139, and a transmission signal processor 141.

The reception signal processor 131 executes a process for correcting power values of the transmission signals outputted from the A/D 113, a process for synchronizing frames of the transmission signals, a process for removing the GIs contained in the transmission signals, and the like.

The FFT 133 performs a Fourier transform of the transmission symbols (see FIG. 5A) respectively constituting the transmission signals outputted from the reception signal processor 131 by use of the selected first mode. The FFT 133 calculates a phase and an amplitude for each of frequencies of the subcarrier in the first mode. The P/S 135 outputs calculation results in series for each of the frequencies of the subcarriers.

The S/P 137 outputs the phase and the amplitude in parallel for each of the frequencies of the subcarriers in accordance with the first mode. The FFT 139 performs an inverse Fourier transform of a signal of the phase and the amplitude outputted for each of frequencies of the subcarriers into a transmission signal constituting the respective transmission symbol in the first mode (see FIG. 5A). The transmission signal processor 141 executes a process for inserting the GIs to the transmission signals outputted from the FFT 139, a process for correcting the power values of the transmission signals, and the like.

The second mode processor 150 executes transmission and reception of the transmission signals by use of the second mode selected by the mode selector 117. The third mode processor 170 executes transmission and reception of the transmission signals by use of the third mode selected by the mode selector 117. Note that, since internal configurations of the second mode processor 150 and the third mode processor 170 are the same as that of the above-described first mode processor 130, detailed explanations thereof will be omitted.

The terminal devices 200-1 to 200-n execute transmission and reception of the transmission signal formed by multiplexing the transmission symbols containing the GI between the terminal devices 200-1 to 200-n and the radio base station 100 by use of at least a part of the plurality of subcarriers. The terminal devices 200-1 to 200-n in this embodiment execute the transmission and reception of the transmission signal by use of one of the plurality of modes (the mode process) in common with the radio base station 100.

Note that, the mode process in the terminal devices 200-1 to 200-n is similar to the above-described mode process (see FIG. 3 to FIG. 5C) in the radio base station 100. Accordingly, detailed explanations will be omitted.

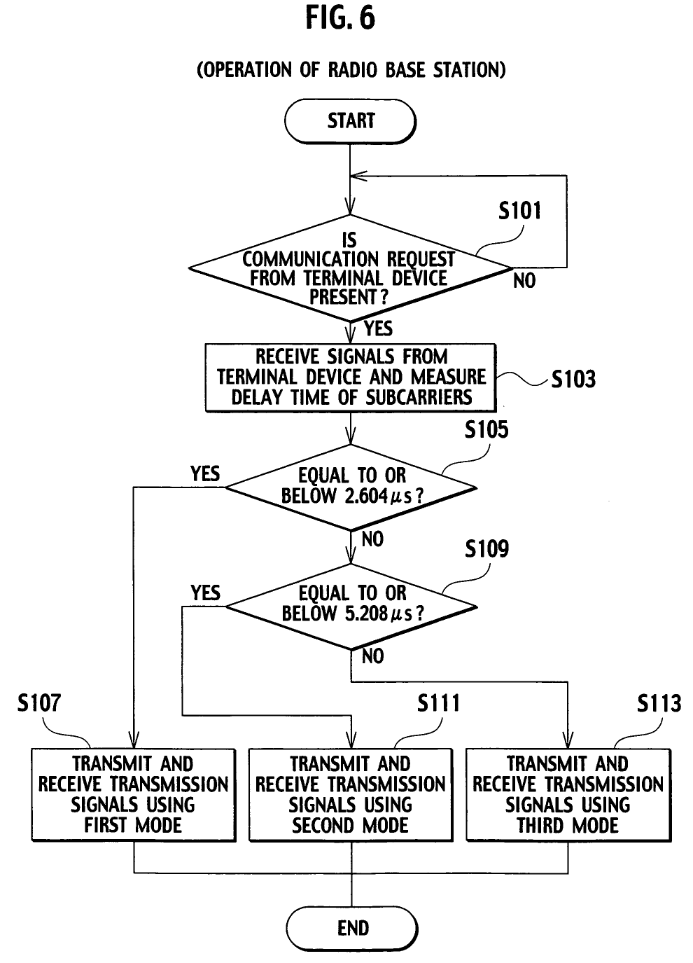

Next, an operation (a radio communications controlling method) of the radio base station 100 in this embodiment will be described with reference to FIG. 6.

As shown in FIG. 6, in Step S101, the radio base station 100 judges whether or not a communication request from any of the terminal devices 200-1 to 200-n is present. The radio base station 100 goes to a procedure in Step S103 when the judgment turns out to be YES or repeats this procedure when the judgment turns out to be NO.

In Step S103, the radio base station 100 measures the delay time for each predetermined time interval, which is determined based on the time point of the subcarrier that arrives first from the terminal device that issues the communication request and the time point of the subcarrier that arrives through the multipath.

In Step S105, the radio base station 100 judges whether or not the measured delay time is equal to or below 2.604 μs. The radio base station 100 goes to a procedure in Step S107 when the judgment turns out to be YES or goes to a procedure in Step S109 when the judgment turns out to be NO.

In Step S107, the radio base station 100 selects the first mode out of the plurality of modes (see FIG. 4A and FIG. 5A). The base station 100 transmits instruction information instructing the terminal device issuing the communication request to perform transmission and reception of the transmission signals by use of the first mode. Then, the radio base station 100 executes transmission and reception of the transmission signals by use of the first mode.

In Step S109, the radio base station 100 judges whether or not the measured delay time is equal to or below 5.208 μs. The radio base station 100 goes to a procedure in Step S111 in a case where the judgment turns out to be YES or goes to a procedure in Step S113 in a case where the judgment turns out to be NO.

In Step S111, the radio base station 100 selects the second mode out of the plurality of modes (see FIG. 4B and FIG. 5B). The base station 100 transmits instruction information instructing the terminal device issuing the communication request to perform transmission and reception of the transmission signals by use of the second mode. Then, the radio base station 100 executes transmission and reception of the transmission signals by use of the second mode.

In Step S113, the radio base station 100 selects the third mode out of the plurality of modes (see FIG. 4C and FIG. 5C). The base station 100 transmits instruction information instructing the terminal device issuing the communication request to perform transmission and reception of the transmission signals by use of the third mode. Then, the radio base station 100 executes transmission and reception of the transmission signals by use of the third mode.

In this way, the radio base station selects the mode in the order of the first mode, the second mode and the third mode along an increase in the measured delay time. Specifically, the radio base station 100 applies the longer GI length than the shortest GI length and the narrower subcarrier interval than the widest subcarrier interval along the increase in the measured delay time.

In other words, the radio base station 100 shifts the mode that changes not only the GI length but also the subcarrier interval as appropriate depending on the length of the measured delay time. For this reason, the radio base station can ensure both delayed wave resistance and fading resistance in good balance even in a situation where a communication environment with a communication counterpart device changes.

Here, the mode may be selected by any of the terminal devices 200-1 to 200-n instead of the selection by the radio base station 100.

### FIRST MODIFIED EXAMPLE

In the above-described embodiment, the first mode processor 130, the second mode processor 150, or the third mode processor 170 allocates subchannels formed of the plurality of subcarriers to a single communication counterpart device (such as the terminal device 200-1) (see FIG. 4).

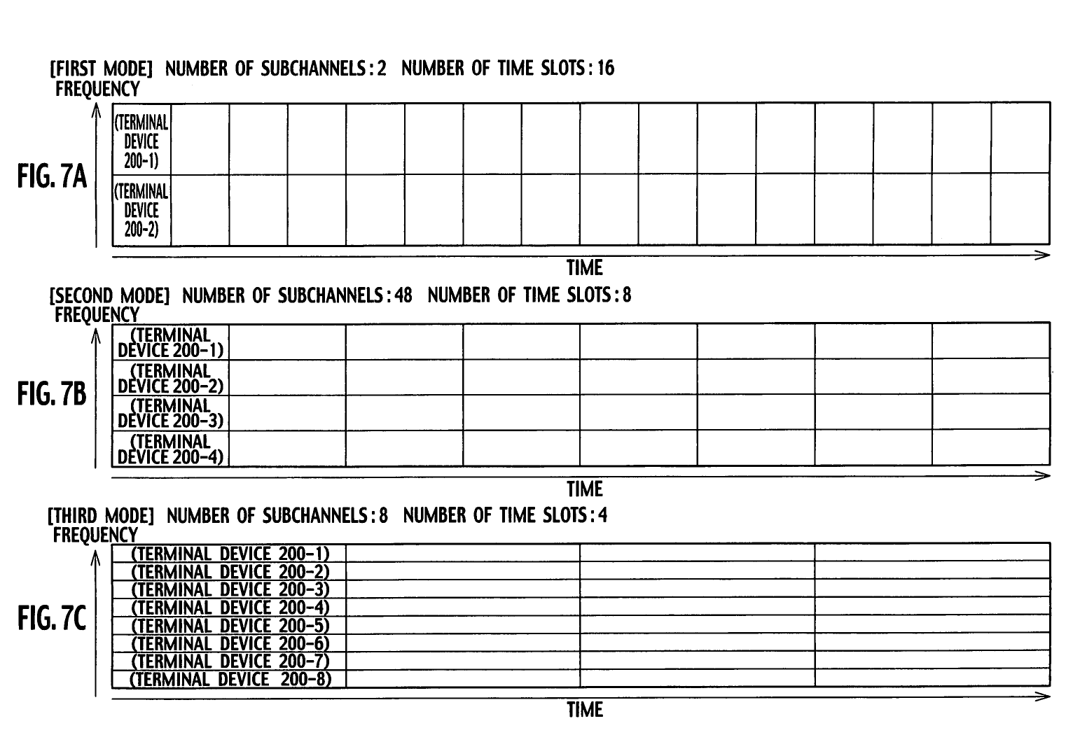

In this modified example, the first mode processor 130, the second mode processor 150, or the third mode processor 170 is configured to allocate subchannels respectively to different communication counterpart devices for each of the time slots obtained by dividing a frame to be repeated at a predetermined unit cycle (such as 2.5 ms) (see FIGS. 4A to 4C and FIG. 7A to 7C).

For example, as shown in FIG. 4A and FIG. 7A, the first mode is applied to two subcarriers in a predetermined frequency band. The subchannels each composed of the single subcarrier are allocated to the terminal devices 200-1 and 200-2, respectively.

As shown in FIG. 4B and FIG. 7B, the second mode is applied to four subcarriers in the predetermined frequency band defined as similar to the first mode. The subchannels each composed of the single subcarrier are allocated to the terminal devices 200-1 to 200-4, respectively.

As shown in FIG. 4C and FIG. 7C, the third mode is applied to eight subcarriers in the predetermined frequency band defined as similar to the first mode. The subchannels each composed of the single subcarrier are allocated to the terminal devices 200-1 to 200-8, respectively.

In this way, the radio base station 100 can allocate the subchannels composed of the plurality of subcarriers to each of the communication counterpart devices (such as the terminal device 200-1) for each of the time slots. Accordingly, the radio base station 100 can ensure delayed wave resistance and the fading resistance in good balance by use of the selected mode while targeting the plurality of communication counterpart devices.

### SECOND MODIFIED EXAMPLE

The mode selector 117 may select any mode on the time slot basis. Further, the mode selector 117 may select any mode (the mode in accordance with the number of subchannels) on the time slot basis in a case where a plurality of subchannels is allocated to a single communication counterpart device.

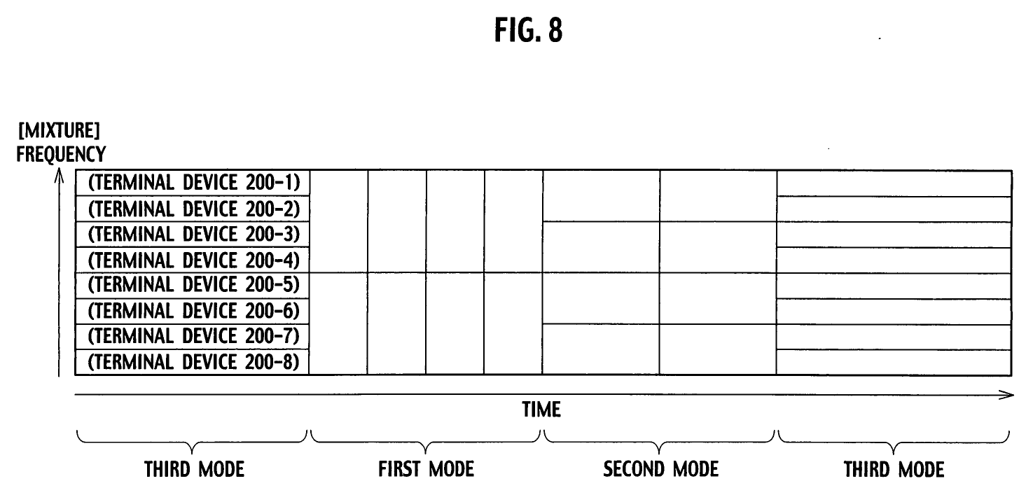

For example, in a case where two subchannels are respectively allocated to the terminal devices 200-1 and 200-2 in a certain time slot as shown in FIG. 8, the radio base station 100 selects the first mode while targeting the two subchannels.

In this way, the radio base station 100 can apply the GI length and the subcarrier interval properly for each of the time slots. Accordingly, the radio base station 100 can ensure both the delayed wave resistance and the fading resistance in good balance for each of the time slots.

### THIRD MODIFIED EXAMPLE

In a case where a plurality of subchannels are allocated to a single communication counterpart device, the mode selector 117 may change the subcarrier interval in accordance with the selected mode with a wider subcarrier interval than the subcarrier interval.

The following explanation will be based on the assumption that the second mode is selected. However, the present invention is not limited only to this selection and it is by all means possible to select the first mode or the third mode instead.

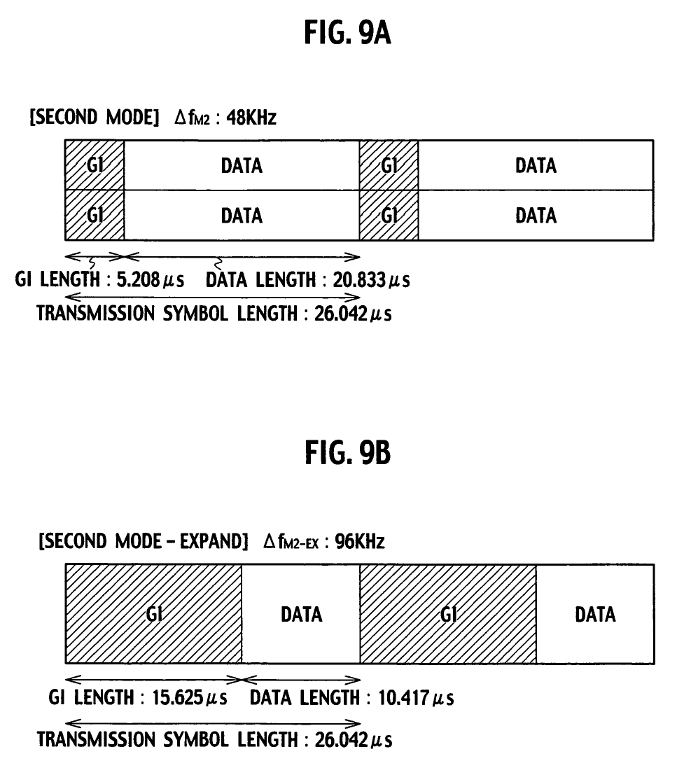

FIG. 9A shows contents of the transmission symbol in accordance with the second mode. FIG. 9B shows contents of the transmission symbol in accordance with a second mode-expand, which is derived from the original second mode.

For example, in a case where the plurality of subchannels are allocated to the single terminal device, the mode selector 117 selects the second mode-expand having the wider subcarrier interval (such as 96 kHz as shown in FIG. 9A) than the subcarrier interval in accordance with the second mode which is originally selected.

Here, the assumption is made that the radio base station 100 and another radio base station (not shown) are located around the communication counterpart device (such as the terminal device 200-1) and the radio base station 100 and the other radio base station are using the same mode. In this case, the radio base station 100 and the other radio base station apply the same subcarrier interval. For this reason, the terminal device 200-1 may be interfered with a subcarrier from the other radio base station in the course of executing transmission and reception of the signals with the radio base station 100.

In this modified example, even in the situation where the radio base station 100 and the other radio base station are using the same mode (such as the second mode), the radio base station 100 can change the subcarrier interval currently used by the other radio base station with the wider subcarrier interval (see the second mode-expand, for example) in a case where the plurality of subchannels are allocated to the single communication counterpart device.

Accordingly, the subcarrier interval used by the radio base station 100 becomes wider than the subcarrier interval used by the other radio base station. Therefore, the terminal device 200-1 can ensure the sufficient fading resistance attributable to the other radio base station even in the course of transmission and reception of the signals with the radio base station 100.

Here, in a case where the plurality of subcarriers are allocated to the single communication counterpart device, the mode selector 117 may change not only the subcarrier interval in accordance with the selected mode with the wider subcarrier interval but may also change the GI length in accordance with the mode with a longer GI length.

For example, the mode selector 117 selects the second mode-expand, which is formed as a combination of the wider subcarrier interval (such as 96 kHz shown in FIG. 9A) than the subcarrier interval in accordance with the selected second mode and the longer GI length (such as 15.625 μs shown in FIG. 9A) than the GI length in accordance with that mode.

In this way, even in the situation where the radio base station 100 and the other radio base station are using the same mode (such as the second mode), the radio base station 100 is able not only to change the subcarrier interval used by the other radio base station with the wider subcarrier interval but also to change the GI length used by the other radio base station with the longer GI length.

Specifically, the subcarrier interval and the GI length used by the radio base station 100 become larger than the subcarrier interval and the GI length used by the other radio base station. Accordingly, even in the course of transmission and reception of the transmission signals to and from the radio base station 100, the communication counterpart device can ensure the sufficient delayed wave resistance in addition to the fading resistance attributable to the other radio base station.

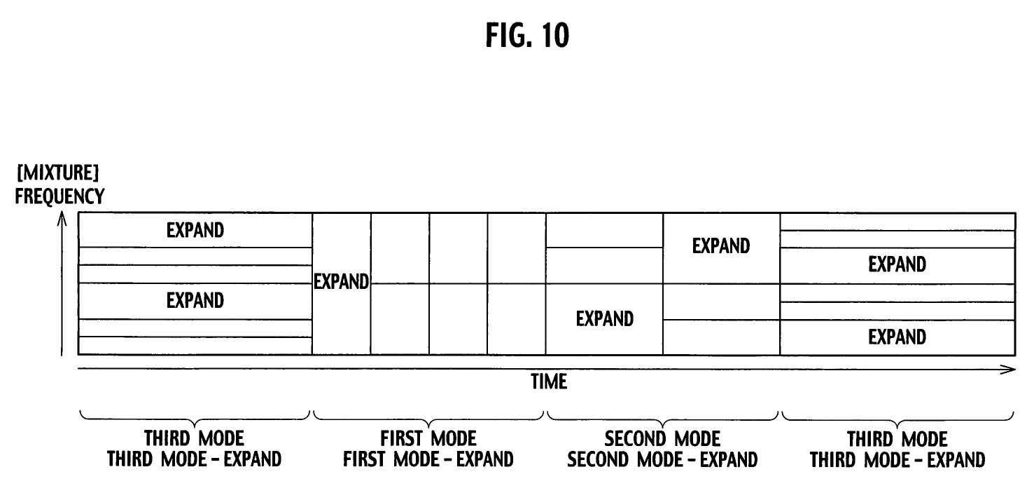

Here, as shown in FIG. 10, in a case where the plurality of subchannels are allocated to the single communication counterpart device, the mode selector 117 may change the subcarrier interval in accordance with the selected mode with the wider subcarrier interval (see a relation between the second mode and the second mode-expand, for example) for each of the time slots.

Alternatively, in a case where the plurality of subchannels are allocated to the single communication counterpart device, the mode selector 117 is able not only to change the subcarrier interval in accordance with the selected mode with the wider subcarrier interval but also to change the GI length in accordance with that mode with the longer GI length for each of the time slots.

The present invention has been described with reference to certain embodiment and examples. It is to be noted, however, that these embodiment and examples are merely typical examples and the present invention will not be limited only to the foregoing. Concrete configurations of the respective constituents may be differently designed or modified as appropriate. Moreover, a combination of the configurations of the embodiment and the modified examples is also acceptable. In addition, it is to be noted that the operation and effects of the embodiment and the modified examples merely represent the most favorable operation and effects obtained by the present invention. Therefore, the operation and effects of the present invention are not limited only to those expressly stated in the descriptions of the embodiment and the respective modified examples.

What is claimed is:

1. A radio communications device configured to execute transmission and reception of a transmission signal formed by multiplexing a transmission symbol containing a guard interval by use of at least a part of a plurality of subcarriers, the radio communications device comprising:
a delay time measurement unit configured to measure delay time determined based on a time point of a subcarrier out of the plurality of subcarriers arriving first and a time point of another subcarrier arriving through multipath at each predetermined time interval;
a mode selector configured to select a mode out of a plurality of modes formed as combinations of a subcarrier interval representing an interval between mutually adjacent subcarriers out of the plurality of subcarriers and the guard interval depending on a length of the delay time; and
a process executing unit configured to execute transmission and reception of the transmission signal by use of the selected mode.

2. The radio communications device according to claim 1, wherein the mode selector is configured to select one of the modes for each of time slots obtained by dividing a frame to be repeated at a predetermined unit cycle.

3. The radio communications device according to claim 2, wherein
the process executing unit allocates subchannels formed of the plurality of subcarriers to a single communication counterpart device, and
the mode selector changes the subcarrier interval in accordance with the selected mode with a subcarrier interval wider than the subcarrier interval in a case where the plurality of subchannels are allocated to the single communication counterpart device.

4. The radio communications device according to claim 1, wherein
a time length of the transmission symbol varies depending on the modes, and
a long transmission symbol having a longer time length has the time length equivalent to an integral multiple of a time length of a short transmission symbol which is shorter than that of the long transmission symbol.

5. A radio communications controlling method with which to execute a transmission and reception of a transmission signal formed by multiplexing a transmission symbol containing a guard interval by use of at least a part of a plurality of subcarriers, the radio communications controlling method comprising the steps of:
measuring delay time determined based on a time point of a subcarrier out of the plurality of subcarriers arriving first and a time point of another subcarrier arriving through multipath at each predetermined time interval;
selecting a mode out of a plurality of modes formed as combinations of a subcarrier interval representing an interval between mutually adjacent subcarriers out of the plurality of subcarriers and the guard interval depending on a length of the delay time; and
executing transmission and reception of the transmission signal by use of the selected mode.

6. The radio communications controlling method according to claim 5, wherein in the step of selecting a mode, one of the modes is selected for each of time slots obtained by dividing a frame to be repeated at a predetermined unit cycle.

7. The radio communications controlling method according to claim 6, wherein
in the step of executing transmission and reception, subchannels formed of the plurality of subcarriers are allocated to a single communication counterpart device, and
in the step of selecting a mode, the subcarrier interval in accordance with the selected mode is changed to a subcarrier interval wider than the subcarrier interval in a case where the plurality of subchannels are allocated to the single communication counterpart device.

8. The radio communications controlling method according to claim 5, wherein
a time length of the transmission symbol varies depending on the modes, and
a long transmission symbol having a longer time length has the time length equivalent to an integral multiple of the time length of a short transmission symbol which is shorter than that of time length than the long transmission symbol.
